(19) United States
(12) Patent Application Publication
(10) Pub. No.: US 2022/0246045 A1
(43) Pub. Date: Aug. 4, 2022

(54) INFORMATION PROCESSING DEVICE AND INFORMATION PROCESSING METHOD

(71) Applicant: KDDI CORPORATION, Tokyo (JP)

(72) Inventors: Takaya TANAKA, Tokyo (JP); Hiroshi KAWANA, Tokyo (JP)

(73) Assignee: KDDI CORPORATION, Tokyo (JP)

(21) Appl. No.: 17/410,670

(22) Filed: Aug. 24, 2021

(30) Foreign Application Priority Data
Jan. 29, 2021 (JP) 2021-013587

(51) Int. Cl. G08G 5/00; B64C 39/02; B64F 1/36; B60L 53/62; B60L 53/66

(52) U.S. Cl. CPC G08G 5/0069; G08G 5/0065; G08G 5/0013; G08G 5/0026; B64C 39/024; B60L 2200/10; B60L 53/62; B60L 53/665; B64C 2201/027; B64C 2201/042; B64F 1/362

(57) ABSTRACT

An information processing device includes a storage unit configured to store setting information representing an association between port identification information, a use condition to use the port, and an available duration to use the port. The information processing device includes a reception unit configured to receive from a user terminal user information relating to the flight vehicle and/or the user and a date and time of use, a determination unit configured to determine that the port identified by the port identification information is available to the flight vehicle when the user information satisfies the use condition while the date and time of use are included in the available duration, and an output unit configured to output to the user terminal the information about the port which the determination unit determines to be available to the flight vehicle.

### CROSS-REFERENCE TO RELATED APPLICATION

The present application claims the priority benefit of Japanese patent Application No. 2021-013587 filed on Jan. 29, 2021, the subject matter of which is hereby incorporated herein by reference.

### BACKGROUND OF THE INVENTION

### 1. Field of the Invention

The present invention relates to an information processing device and an information processing method, which are designed to carry out processing of information about ports used by flight vehicles to make takeoff or landing.

### 2. Description of Related Art

Patent Document 1 (i.e., WO 2018/198313A1) discloses an unmanned aerial vehicle action plan creation system, which is configured to receive a flight area and a flight objective for a flight vehicle such as a drone to fly in the air, to generate a flight path according to the flight area and the flight objective, and to control the flight vehicle to fly according to the flight path.

Generally, flight vehicles are designed to make takeoff or landing at designated ports, wherein ports used by flight vehicles are managed by individual persons or organizations. For example, two types of ports, i.e., private ports available for limited users and public ports for common users managed by countries or local municipalities, can be provided to flight vehicles. Conventionally, private ports available for limited users may not permit utilization by users other than limited users. For this reason, a problem may arise in that private ports might easily waste time uselessly when they are not used by anybody else.

The present invention is made to solve the above problem and aims to improve convenience for various users to make use of ports for flight vehicles to make a takeoff or landing.

### SUMMARY OF THE INVENTION

In a first aspect of the present invention, an information processing device includes a reception unit configured to receive from a user terminal operated by a user to control a flight vehicle to make a takeoff or landing at a port, user information relating to at least one of the flight vehicle and the user as well as a date and time of use scheduled for the flight vehicle to use the port and configured to receive from a manager terminal operated by a manager to manage the port, port identification information to identify the port, an available duration to use the port, and a user condition to use the port which is set for each available duration; a setting unit configured to store on a storage unit, setting information representing an association between the port identification information, the available duration, and the use condition set for each available duration which are received by the reception unit; a determination unit configured to determine whether or not the port identified by the port identification information is available to the flight vehicle based on a decision as to whether or not the user information satisfies the use condition set for each available duration and a decision as to whether or not the date and time of use are included in the available duration; and an output unit configured to output to the user terminal the information about the port which the determination unit determines to be available to the flight vehicle.

In the above, the output part may output to the user terminal a route from the position of the flight vehicle to the position of the port which the determination unit determines to be available to the flight vehicle.

In addition, the output unit may output to the user terminal the information about the port which the determination unit determines to be available to the flight vehicle and which belongs to a predetermined range of area including a flight path along which the flight vehicle is scheduled to fly.

The storage unit may store the use condition representing multiple usages of the port, wherein the determination unit may determine that the port is available to the flight vehicle when the usage of the flight vehicle is included in the usages indicated by the use condition.

The storage unit may store the use condition representing a priority of each usage among a plurality of usages, wherein when the flight vehicle competes with a secondary flight vehicle for use of the port, the determination unit may determine that the port is available to the flight vehicle while the port is unavailable to the secondary flight vehicle when the flight vehicle has a higher priority of usage than the secondary flight vehicle.

In addition, the storage unit may store the use condition representing user attributes applicable to the port, wherein the determination unit may determine that the port is available to the flight vehicle when a user attribute of the user who attempts to control the flight vehicle is included in the user attributes indicated by the use condition.

Moreover, the storage unit may store the use condition representing airframe properties applicable to the port, wherein the determination unit may determine that the port is available to the flight vehicle when an airframe property of the flight vehicle is included in the airframe properties indicated by the use condition. The information processing device may further include a charging unit configured to determine an amount of payment claimed against the user based on at least one of a stay time of the flight vehicle staying at the port and an amount of electricity consumed by the flight vehicle at the port, thus generating charging information including the amount of payment.

In a second aspect of the present invention, an information processing method includes the steps of: receiving from a user terminal operated by a user to control a flight vehicle to make a takeoff or landing at a port, the user information relating to at least one of the flight vehicle and the user as well as a date and time of use scheduled for the flight vehicle to use the port; receiving from a manager terminal operated by a manager to manage the port, port identification information to identify the port, an available duration to use the port, and a user condition to use the port which is set for each available duration; storing on a storage unit, setting information representing an association between the port identification information, the available duration, and the use condition set for each available duration which are received; determining whether or not the port identified by the port identification information is available to the flight vehicle based on a decision as to whether or not the user information satisfies the use condition set for each available duration and a decision as to whether or not the date and time of use are included in the available duration; and outputting to the user terminal the information about the port which the determination unit determines to be available to the flight vehicle.

According to the present invention, it is possible to achieve an advantageous effect to make use of a port used for a flight vehicle to make a takeoff or landing by various users who aim to control flight vehicles for different purposes.

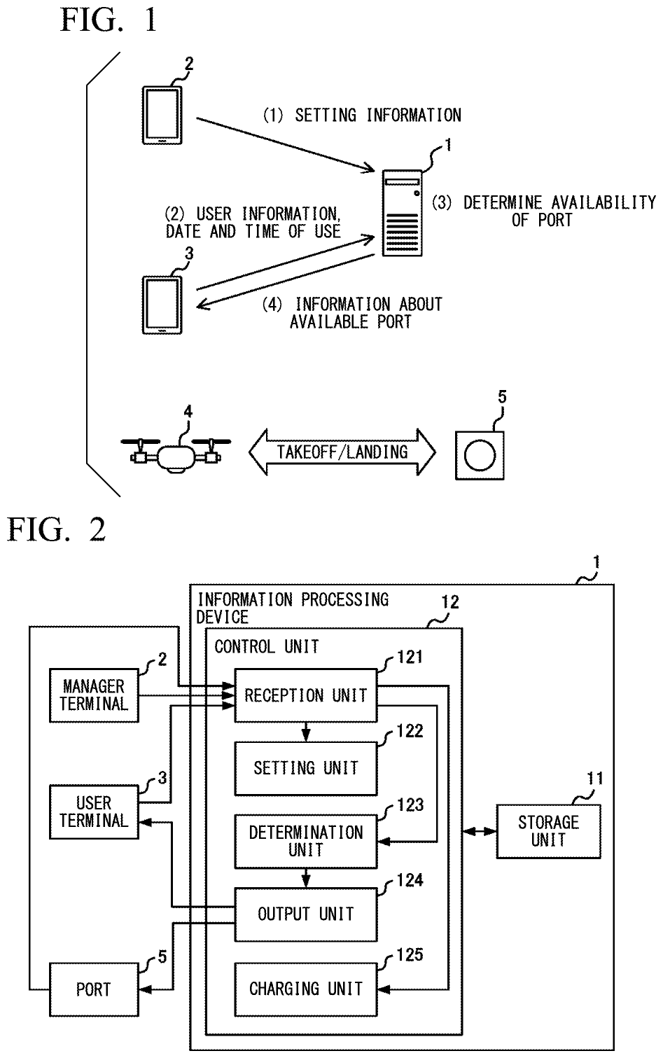

FIG. 1 is a schematic diagram of an information processing system realizing the exemplary embodiment of the present invention.

FIG. 2 is a block diagram of an information processing device included in the information processing system.

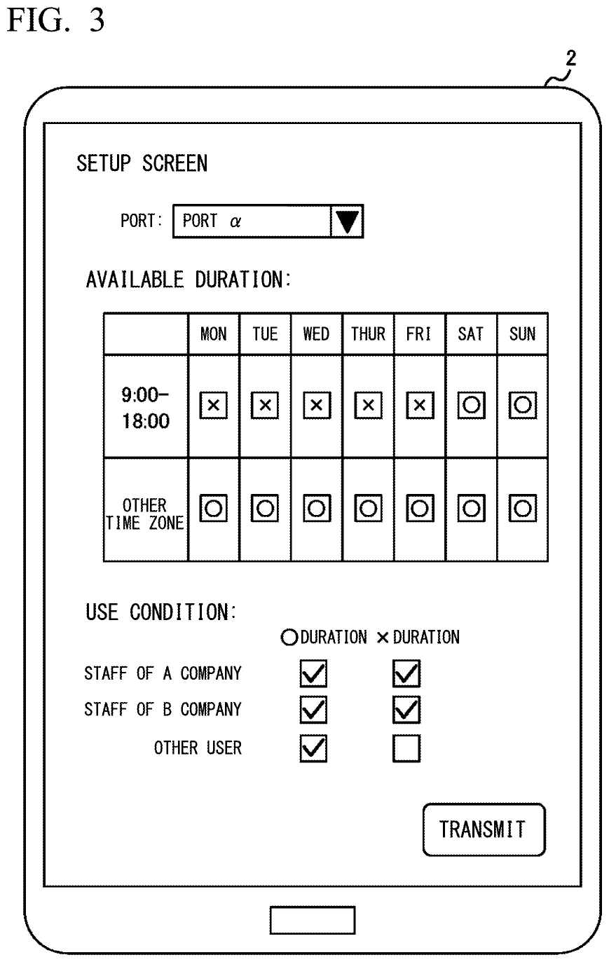

FIG. 3 is a screenshot showing a setup screen for accepting an input of setting information on a manager terminal.

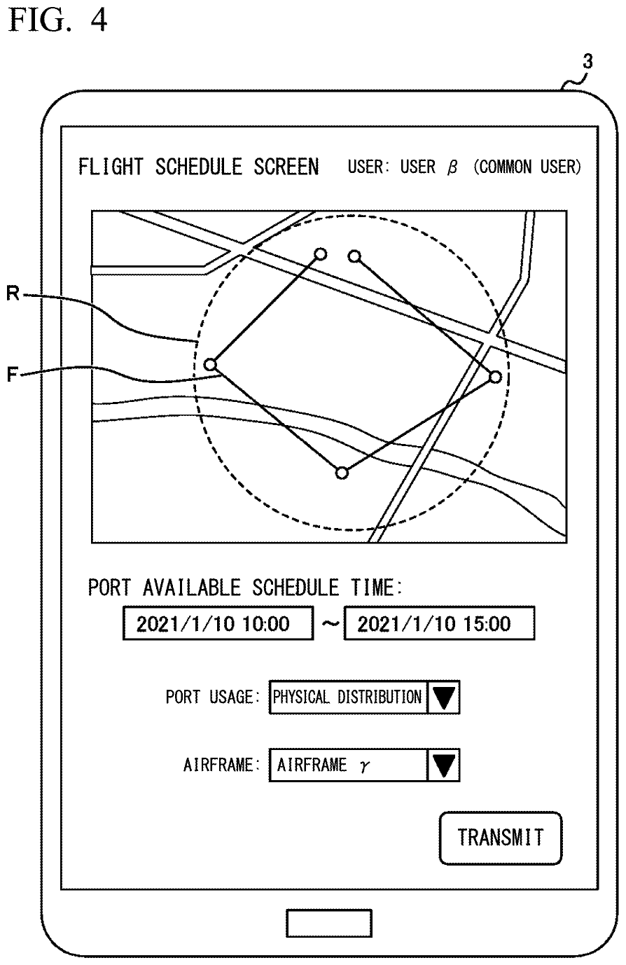

FIG. 4 is a screenshot showing a flight schedule screen for accepting an input of flight schedule information on a user terminal.

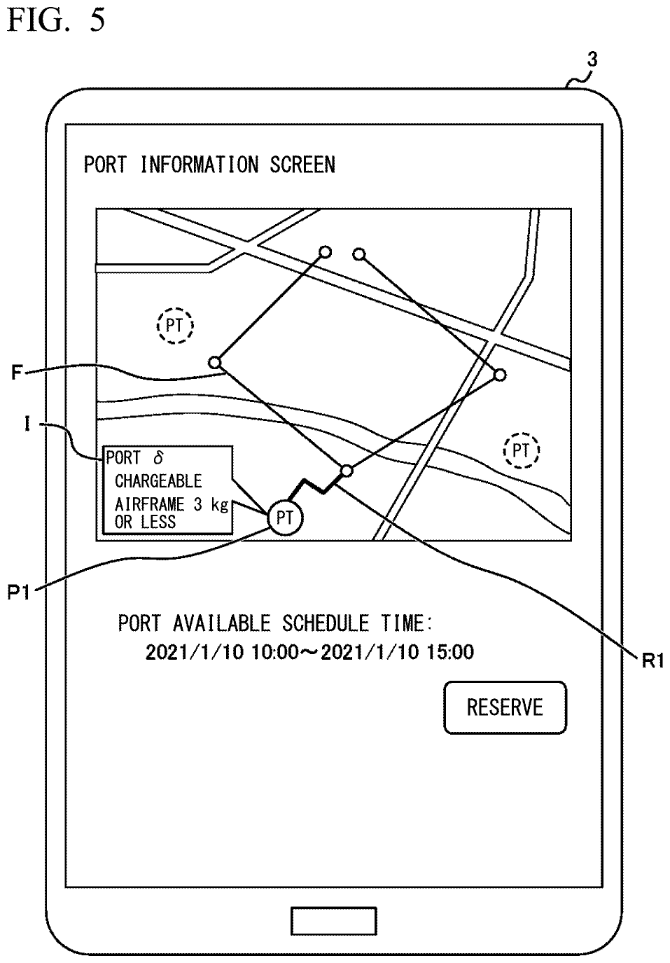

FIG. 5 is a screenshot showing a port information screen for displaying an available port on the user terminal.

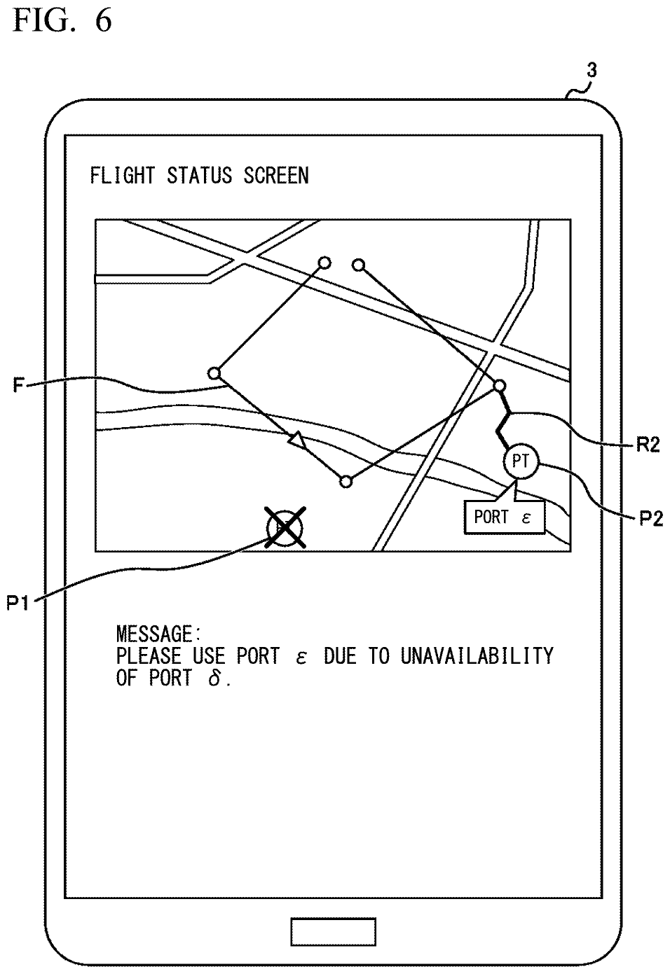

FIG. 6 is a screenshot showing a flight status screen for displaying the information of an alternative port on the user terminal.

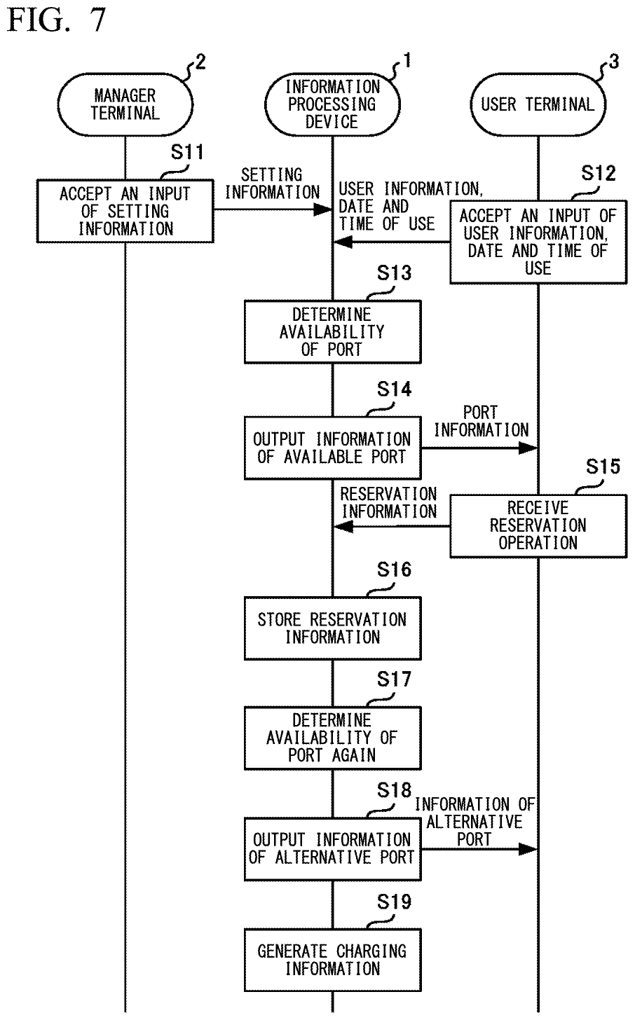

FIG. 7 is a sequence diagram of an information processing method to be executed by the information processing system.

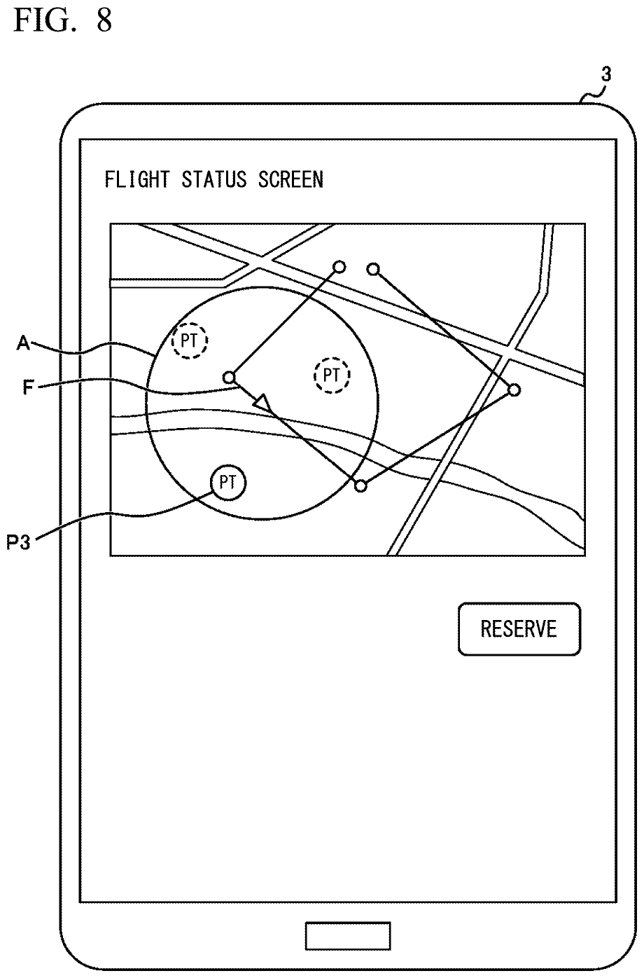

FIG. 8 is a screenshot showing a flight status screen for making a reservation of a port by a flight vehicle during flight by means of a user terminal.

### DETAILED DESCRIPTION OF THE EXEMPLARY EMBODIMENT

The present invention will be described with respect to an information processing device and an information processing method by way of examples with reference to the accompanying drawings, wherein parts identical to those shown in drawings are designated by the same reference numerals; hence, duplicate descriptions thereof will be omitted here.

FIG. 1 is a schematic diagram of an information processing system realizing the exemplary embodiment of the present invention. The information processing system includes an information processing device 1, a manager terminal 2, a user terminal 3, a flight vehicle 4, and a port 5. In this connection, the information processing system may include other terminals or devices.

The information processing device 1 is a computer configured to determine whether the flight vehicle 4 is permitted to use the port 5 when a user operates the flight vehicle 4 to fly according to setting information set by a manager. The information processing device 1 may be configured of a single device or multiple devices. In this connection, the information processing device 1 may be configured of a single virtual server or multiple virtual servers which can operate on a cloud system serving as a set of computer resources.

The manager terminal 2 is a computer to be used by a manager. For example, the manager terminal 2 is an information tell final such as a smartphone, a tablet terminal, and a personal computer. For example, the manager is a person who may own, manage, or provide the port 5. The manager terminal 2 includes a display unit such as a liquid-crystal display configured to display various types of information and an operation unit such as a touch panel configured to input a manager operation made by a manager. The manager terminal 2 is configured to transmit or receive various types of information with the information processing device 1 by radio.

The user terminal 3 is a computer to be used by a user. For example, the user terminal 3 is an information terminal such as a smartphone, a table terminal, and a personal computer. The user is a person who may own, manage, or operate the flight vehicle 4. The user terminal 3 includes a display unit such as a liquid-crystal display configured to display various types of information and an operation unit such as a touch panel configured to input a user operation made by a user. The user terminal 3 is configured to transmit or receive various types of information with the information processing device 1 by radio.

The flight vehicle 4 is an unmanned flight vehicle such as a drone configured to fly along a flight path designated by a user and to carry out a predetermined operation (e.g., a task or activities). In this connection, the flight vehicle 4 may be a manned flight vehicle such as an aircraft and a flyable vehicle capable of flying in the air. The flight vehicle 4 is equipped with a chargeable battery such that the flight vehicle 1 can operate using electric power of the battery. For example, activities to be performed by the flight vehicle 4 may include transportation of objects along flight paths, capturing images of situations along flight paths, distributing articles (e.g., agricultural chemicals) along flight paths, and emitting information (e.g., sound or light) along flight paths.

The flight vehicle 4 is configured to perform communications using communication services provided by communication carriers (or common carriers).

The port 5 serves as takeoff/landing facilities for the flight vehicle 4 to make takeoff or landing. For example, the port 5 may be a drone port for a drone (e.g., the flight vehicle 4) to make takeoff or landing. For example, the port 5 may be equipped with an electric charger to provide electric power to the flight vehicle 4 and to charge the battery of the flight vehicle 4 when connected with the flight vehicle 4 which makes landing at the port 5.

Next, an overview of processes to be carried out by the information processing device 1 of the exemplary embodiment will be described below. The information processing device 1 is configured to receive the setting information from the manager terminal 2 and to store the setting information on a storage unit (see (1) of FIG. 1), wherein the setting information represents an association between the port-identification information for identifying the port 5, the use condition to make use of the port 5, and the available duration in which the port 5 is available for the flight vehicle 4 to make takeoff or landing. In addition, the information processing device 1 is configured to receive from the user terminal 3 the user information relating to at least one of the user and the flight vehicle 4 as well as the date and time for the flight vehicle 4 to use the port 5 (see (2) of FIG. 1). For example, the user information can be regarded as the information about an organization which the user belongs to and the usage of the flight vehicle 4 to use the port 5.

The information processing device 1 is configured to determine whether or not the port 5 is available for the flight vehicle 4 to make takeoff or landing according to a decision as to whether or not the user information satisfies the use condition and a decision as to whether or not the date and time of use are included in the available duration (see (3) of FIG. 1). Upon determining that the port 5 is available to the flight vehicle 4, the information processing device 1 is configured to output to the flight vehicle 4 the information to identify the port 5 which is determined to be available to the flight vehicle 4.

As described above, upon receiving a setting of the use condition and the available duration of the port 5 from the manager, the information processing device 1 may determine whether or not to permit the flight vehicle 4 to use the port 5 according to a decision as to whether or not the user information and the date and time of use relating to the user of the flight vehicle 4 or the flight vehicle 4 to use the port 5 satisfy the use condition and the available duration. That is, the manager may switch over the availability of the port 5 for each time zone and for each of the flight vehicle 4 to use the port 5 and the user of the flight vehicle 4. Therefore, the information processing device 1 can provide an opportunity to use the port 5 for various users without being limited to specific users when making a takeoff or landing of the flight vehicle 4.

### [Configuration of Information Processing Device 1]

FIG. 2 is a block diagram of the information processing device 1 according to the exemplary embodiment of the present invention. In FIG. 2, various lines having arrow symbols indicate main data flows between constituent elements, however, it is possible to conceive of other data flows than those shown in FIG. 2. In this connection, FIG. 2 does not necessarily show the blocks in units of hardware (or units of devices) but the blocks in units of functions. For this reason, an arbitrary number of blocks should be collectively embedded in a single device or separately embedded in multiple devices. Transmission and reception of data between blocks can be realized by data buses, networks, portable storage media, or any arbitrary means.

The information processing device 1 includes a storage unit 11 and a control unit 12. The storage unit 11 is a storage media such as ROM (Read-Only Memory), RAM (Random-Access Memory), hard-disk drives, and the like. The storage unit 11 is configured to store programs executable by the control unit 12 in advance. In addition, the storage unit 11 stores in advance the port information representing an association between the port identification information to identify the port 5, the position of the port 5, and the property of the port 5.

The storage unit 11 stores in advance the user information representing an association between the user identification information to identify a user and user attributes. In addition, the storage unit 11 stores in advance the airframe information representing an association between the airframe identification information to identify the flight vehicle 4 and the type of airframe. Moreover, the storage unit 11 stores the setting information set by a manager, wherein the setting information represents an association between the port identification information to identify the port 5, the use condition to make use of the port 5, and the available duration in which the port 5 is available to the flight vehicle 4.

The control unit 12 includes a reception unit 121, a setting unit 122, a determination unit 123, an output unit 124, and a charging unit 125. For example, the control unit 12 is configured of a processor such as a CPU (Central Processing Unit), which is configured to execute programs stored on the storage unit 11 so as to achieve the functions as the reception unit 121, the setting unit 122, the determination unit 123, the output unit 124, and the charging unit 125.

Next, the exemplary embodiment of the present invention will be described with respect to detailed configurations of the information processing device 1 to perform the processing of information about the port 5 used by the flight vehicle 4 when making a takeoff or landing. First, the reception unit 121 receives from the manager terminal 2 the setting information representing an association between the port identification information (or a port ID (Identification)) to identify the port 5 used by the flight vehicle 4 to make a takeoff or landing, the use condition to make use of the port 5, and the available duration in which the port 5 is available to the flight vehicle 4. That is, the setting information indicates the use condition as to whether or not to make use of the port 5 for each time zone corresponding to the available duration.

For example, the available duration is a timewise range set for each date or a timewise range set for each day of a week. For example, the use condition includes at least one of the user attributes representing the attributes of a user who may be permitted to use the port 5, the airframe property of the flight vehicle 4 which may be permitted to use the port 5, and the usage of the port 5 used by the flight vehicle 4. For example, the user attributes may indicate whether or not the user of the flight vehicle 4 belongs to a specific organization. For example, the airframe property indicates a kind (or a type) of the flight vehicle 4. The type of the flight vehicle 4 can be represented by the weight of an airframe, the size of an airframe, sound volume produced by propellers, the specification of an airframe (e.g., a wind endurance function), or other properties of an airframe. For example, the usage may represent the objective of the flight vehicle 4 to use the port 5 such as physical distribution, recreation, and emergency landing or the like. In this connection, the use condition may include an upper-limit number of airframes which can be permitted to use the port 5 when the port 5 is concurrently available to multiple flight vehicles 4.

In addition, the use condition may include a priority in each of usages. In this case, for example, the use condition may prioritize the flight vehicle 4, which needs to achieve an objective to use the port 5 for emergency-landing usage, to prioritize use of the port 5 over other flight vehicles having other objectives to use the port 5.

FIG. 3 is a screenshot showing a setup screen for receiving an input of the setting information on the manager terminal 2. Triggered by a manager's login to the information processing device 1 by a manager using the manager identification information (or a manager ID to identify the manager), the manager terminal 2 displays a setup screen on a display screen thereof.

The manager terminal 2 receives an input of the setting information including the use condition and the available duration on the setup screen. The manager terminal 2 receives an input of the use condition designated by a manager for each available duration on the setup screen. In FIG. 3, the manager should select a port ID subjected to a setting among multiple port IDs associated with the manager ID so as to classify available durations using a symbol “o” or “x” for each time zone and for each day of a week. Subsequently, the manager sets the use condition such as user attributes for each available duration classified by the symbol of “o” or “x”.

The manager terminal 2 may accept an input of setting a specific date and its time zone as the available duration, which is not necessarily limited to a certain date of a week and its time zone. In addition, the manager terminal 2 may accept an input of setting an airframe type of the flight vehicle 4 or a usage of the port 5 used by the flight vehicle 4 as the use condition for each available duration, which is not necessarily limited to user attributes. Moreover, the manager terminal 2 may accept an input of setting a usage fee claimed against a user operating the flight vehicle 4 for the usage of the port 5.

Alternatively, the manager terminal 2 may accept an input of the setting information according to other methods.

In the information processing device 1, the reception unit 121 is configured to receive the setting information representing the information input to the manager terminal 2. The setting unit 122 is configured to store on the storage unit 11 the setting information representing an association between the available duration, the use condition, and the port ID received by the reception unit 121.

Next, the reception unit 121 is configured to receive from the user terminal 3 the flight schedule information including the user information representing at least one of the flight vehicle 4 and the user of the flight vehicle 4 as well as the date and time of using the port 5 by the flight vehicle 4.

FIG. 4 is a screenshot showing a flight schedule screen for accepting an input of flight schedule information on the user terminal 3. Triggered by a user's login to the information processing device 1 using the user identification information (i.e., a user ID to identify the user), the user terminal 3 is configured to display a flight schedule screen on a display screen thereof.

For example, the user terminal 3 may enter the user's designation of a flight area R indicated by a planar range designated on a map displayed on the flight schedule screen. In addition, the user terminal 3 may enter the user's designation of a flight path F indicated by a linear path designated in the flight area R on the map displayed on the flight schedule screen. In this connection, the user terminal 3 may enter the user's designation of the flight path F or the flight area R. Alternatively, the user terminal 3 may enter the user's designation of the flight area R or the flight path F in a three-dimensional manner including a position and an altitude of the flight vehicle 4. The user terminal 3 is configured to enter the user's designation of a scheduled date/time for the flight vehicle 4 to use the port 5, the usage of the port 5 used by the flight vehicle 4, and the airframe identification information (i.e., an airframe ID to identify the flight vehicle 4 to fly in the air). For example, the date/time of use is defined as a duration designated between a start date/time and an end date/time. The user terminal 3 may accept an input of other information. For example, the user terminal 3 may accept an input of the number of airframes corresponding to multiple flight vehicles 4 and an input of airframe IDs for multiple flight vehicles 4.

In the information processing device 1, the reception unit 121 is configured to receive from the user terminal 3 the flight schedule information including the user ID representative of a user to use the user terminal 3 and the input information of the user terminal 3.

The determination unit 123 is configured to determine the user information and the date and time of use based on the flight schedule information received by the reception unit 121. The determination unit 123 is configured to acquire user attributes associated with the user ID included in the flight schedule information on the storage unit 11. The determination unit 121 is configured to acquire an airframe type associated with the airframe ID included in the flight schedule information on the storage unit 11, thus acquiring the property of an airframe corresponding to the acquired airframe type. Subsequently, the determination unit 123 is configured to determine the user information including the usage, the property of an airframe and the acquired user attributes. In addition, the determination unit 123 is configured to determine the date and time of use included in the flight schedule information.

The determination unit 123 is configured to determine the use condition and the available duration associated with the port ID with respect to a single port ID or multiple port IDs indicated by the setting information stored on the storage unit 11.

Subsequently, the determination unit 123 is configured to determine whether or not the port 5 identified by the port ID is available to the flight vehicle 4 according to a decision as to whether or not the user information satisfies the use condition and a decision as to whether or not the date and time of use are included in the available duration. That is, the determination unit 123 determines that the port 5 identified by the port ID associated with the use condition and the available duration is available to the flight vehicle 4 on the condition that the user information satisfies the use condition while the date and time of use are included in the available duration.

The determination unit 123 may solely use a port ID of a single port 5 or port IDs of multiple ports 5 located in a predetermined range of area including a flight path (e.g., a range of one-kilometer (1 km) distance from the flight path) when a single port ID or multiple port IDs are indicated by the setting information stored on the storage unit 11. Accordingly, the information processing device 1 is able to notify a user of only the available port(s) 5 located in the vicinity of a flight path scheduled for the flight vehicle 4 to fly in the air.

Specifically, the determination unit 123 determines that the port 5 is available to the flight vehicle 4 when user attributes included in the user information are included in use attributes indicated by the use condition; however, the determination unit 123 determines that the port 5 is unavailable to the flight vehicle 4 when an airframe property of the flight vehicle 4 included in the user information is not included in airframe properties indicated by the use condition. Accordingly, the information processing device 1 is able to switch over the availability of the port 5 for each time zone and for each airframe property of the flight vehicle 4 representing a large/small size of the flight vehicle 4 as well as a heavy/light weight of the flight vehicle 4. In addition, the determination unit 123 determines that the port 5 is available to the flight vehicle 4 when the usage included in the user information is included in usages indicated by the use condition; however, the determination unit 123 determines that the port 5 is unavailable to the flight vehicle 4 when the usage included in the user information is not included in usages indicated by the use condition. Accordingly, the information processing device 1 is able to switch over the availability of the port 5 for each time zone and for each usage of the port 5 used by the flight vehicle 4 such as physical distribution by the flight vehicle 4 and an emergency landing of the flight vehicle 4 at the port 5.

In addition, the determination unit 123 determines that the port 5 is available to the flight vehicle 4 on the condition that the number of airframes included in the user information is equal to or below the upper-limit number of airframes indicated by the use condition; however, the determination unit 123 determines that the port 5 is unavailable to the flight vehicle 4 when the number of airframes included in the user information is larger than the upper-limit number of airframes indicated by the use condition. The aforementioned descriptions refer to examples of use conditions permitting the flight vehicle 4 to use the port 5; but it is possible to employ use conditions not permitting the flight vehicle 4 to use the port 5. In this case, the determination unit 123 may determine that the port 5 is available to the flight vehicle 4 when various types of information of the user information are not included in the use condition (i.e., the use-unpermitted condition); however, the determination unit 123 may determine that the port 5 is unavailable to the flight vehicle 4 when various types of information of the user information are included in the use condition.

Upon determining that any one of the ports 5 is available to the flight vehicle 4, the determination unit 123 may determine a route from the position of the flight vehicle 4 on the flight path to the position of the port 5. For example, the position of the flight vehicle 4 on the flight path may be a point closest to the available port 5 on the flight path or a point designated by a user on the flight path. The position of the port 5 is acquired from the port information which is stored on the storage unit 11 in advance.

In this connection, the determination unit 123 may determine a route from the position of the flight vehicle 4 on the flight path to the position of the available port 5 by executing the already-known path search process, thus notifying the output unit 124 of the determined route associated with the available port 5. Accordingly, the information processing device 1 may provide a user with a suggestion about a route along which the flight vehicle 4 is controlled to fly toward the available port 5. It is possible for the determination unit 123 to determine routes to multiple ports 5 when multiple ports 5 are available to the flight vehicle 4. In addition, the determination unit 123 may select a single port 5 suited to a selection condition designated by a user from among multiple ports 5 based on routes determined for multiple ports 5. In this case, the user may designate a selection condition to select a route along which the flight vehicle 4 is controlled to fly and reach its destination in the shortest time, a route requiring a low usage fee (wherein the usage fee means an amount of payment needed to use the route or the port 5), or a safe route (which can circumvent urban areas or which may experience a small influence of weather).

Subsequently, the determination unit 123 selects a single port 5 from among multiple ports 5 according to the selection condition designated by a user, thus notifying the output unit 124 of the selected port 5 and the determined route. That is, the information processing device 1 may provide a suggestion about a single port 5 suited to the selection condition designated by a user among multiple available ports 5.

The output part 124 outputs to the user terminal 3 the information representing a single port 5 or multiple ports 5, which are determined to be available to the flight vehicle 4 by the determination unit 123, together with the information representing the flight path scheduled for the flight vehicle 4 to fly in the air. For example, the information representing the available port(s) 5 includes the port ID(s) as well as the position and property of the port 5 indicated by the port information which is stored on the storage unit 11 in advance. For example, the position of the port 5 is represented by an address of a residence or coordinates of the port 5. For example, the property of the port 5 includes various types of information relating to facilities of the port 5 such as a capacity/incapacity of charging, a chargeable airframe type, a charging time, and usage fees. In addition, the output unit 124 outputs to the user terminal 3 the route from the position of the flight vehicle 4 on the flight path to the position of the available port 5.

Accordingly, the information processing device 1 is able to notify a user of the available port 5 which is available to the flight vehicle 4 in an attempt to fly in the air.

FIG. 5 is a screenshot showing a port information screen for displaying the information about the available port 5 on the user terminal 3, wherein symbols “Pt” means “port”. In FIG. 5, the user terminal 3 is configured to display on a map a flight path F, a port symbol P1 representing the port 5, and a route RI toward the port 5 based on the information output from the information processing device 1. In this connection, the user terminal 3 may solely display the available port 5 on the map or display the available port 5 and the unavailable port 5 in different manners. When a user selects any one port symbol P1 on the map, the user terminal 3 is configured to display information I representing the property of the port 5 (i.e., a capacity/incapacity of charging, a chargeable airframe type, a charging time, a usage fee, and the like) corresponding to the selected port symbol P1 in association with the selected port symbol P1.

When a user performs a reservation operation (e.g., a user may select a reservation button on the screen) with respect to any one port 5 on the map displayed on the user terminal 3, the reception unit 121 of the information processing device 1 is configured to receive from the user terminal 3 the reservation information including the date and time of use as well as the port ID of the reserved port 5. The reception unit 121 stores on the storage unit 11 the reservation information received from the user terminal 3 in association with the user ID of a user who has used the user terminal 3 and the airframe ID of the flight vehicle 4. Accordingly, the information processing device 1 is able to receive a user's reservation to use the port 5 upon providing the user with the information about the available port 5.

In addition, the output unit 124 may carry out a control to use the port 5 based on the reservation information stored on the storage unit 11. For example, the output unit 124 may output to the port 5 the control information capacitating the user to use the port 5 at a start timing of the date and time of use indicated by the reservation information or another control information preventing the user from using the port 5 at an end timing of the date and time of use indicated by the reservation information.

According to the control information output from the information processing device 1, the port 5 may switch over the availability of charging or the availability of utilizing the port by opening or closing a concealment cover or the like.

Specifically, when the flight vehicle 4 makes landing at the port 5, the port 5 may open a concealment cover on the condition that a communication device associated with the port 5 authenticates the airframe ID of the flight vehicle 4 upon receiving the airframe ID from the flight vehicle 4. Alternatively, when the flight vehicle 4 makes landing at the port 5, the flight vehicle 4 may read the port ID indicated by codes (or a two-dimensional barcode) attached to the port 5 using a camera, thus transmitting the port ID to the information processing device 1. In this case, the information processing device 1 will transmit the control information for opening a concealment cover to the port 5 corresponding to the port ID read by the flight vehicle 4 on the condition that the port ID included in the reservation information of the flight vehicle 4 matches the port ID read by the flight vehicle 4. Accordingly, the information processing device 1 is able to carry out a control to use the port 5 according to a user's reservation to use the port 5.

After completion of a user's reservation to use the port 5 (e.g., during a flight of the flight vehicle 4), the determination unit 123 may determine the availability of the port 5 again. For example, it is possible to assume a situation in which after a first user makes a reservation to use the port 5 for the usage of “physical distribution”, a second user may attempt to make a reservation to use the port 5 for the usage of “emergency landing”. In this connection, the use condition of the port 5 may stipulate that the usage of “emergency landing” is given a higher priority than the usage of “physical distribution”.

When the use condition stipulates that a priority of usage of a first flight vehicle 4a is higher than a priority of usage of a second flight vehicle 4b, for example, the determination unit 123 determines that the port 5 is available to the first flight vehicle 4a while the port 5 is unavailable to the second flight vehicle 4b. In the aforementioned situation in which a priority of the usage of “emergency landing” is higher than a priority of the usage of “physical distribution”, the determination unit 123 determines that the port 5 is available to the second user's flight vehicle 4 while the port 5 is unavailable to the first user's flight vehicle 4. Subsequently, the reception unit 121 displays the port information screen of FIG. 5 on the second user's user terminal 3 so as to accept a second user's reservation to use the port 5.

When the port 5 cannot be used by the second user due to the first user's reservation of the port 5, the output unit 124 may provide the first user with a suggestion to use an alternative port 5a different from the port 5. In this case, the output unit 124 may extract the alternative port 5a as another port 5, which is different from the original port 5 reserved by the first user and which is located in a predetermined range of area including a flight path (e.g., a range of one-kilometer (1 km) distance from the flight path) among a single port 5 or multiple ports 5 which are determined to be available to the flight vehicle 4 by the determination unit 123.

The output unit 124 is configured to output to the first user's user terminal 3 the extracted information about the alternative port 5a together with the information about the flight path scheduled for the flight vehicle 4 to fly in the air. The user terminal 3 displays the output information of the information processing device 1 on the display screen thereof. This makes it possible for the first user to use the alternative port 5a even when the port 5 is determined to be unavailable to the flight vehicle 4 after completion of a reservation to use the port 5.

In addition, the output unit 124 may automatically store on the storage unit 11 the reservation information including the port ID of the alternative port 5 and the date and time of use in association with the user ID of the first user and the airframe ID of the flight vehicle 4.

Moreover, the determination unit 123 may determine a route from the position of the flight vehicle 4 on the flight path to the position of the alternative port 5a. For example, the position of the flight vehicle 4 on the flight path is defined as the current position of the flight vehicle 4 during flight. The position of the alternative port 5a can be acquired from the port information stored on the storage unit 11 in advance. The determination unit 123 may determine a route from the position of the flight vehicle 4 on the flight path to the position of the alternative port 5a by executing the well-known path search process, thus notifying the output unit 124 of the determined route in association with the alternative port 5a. The output unit 124 outputs to the user terminal 3 the route from the position of the flight vehicle 4 on the flight path to the position of the alternative port 5a.

FIG. 6 is a screenshot showing a flight status screen for displaying the information about the alternative port 5a on the user terminal 3, wherein a symbol “PT” means “port”. FIG. 6 shows an example of a screen image to provide a user with a suggestion to use the alternative port 5a since the port 5 becomes unavailable to the flight vehicle 4 during flight irrespective of a user's reservation to use the port 5. In FIG. 6, the user terminal 3 displays on the map the current position of the flight vehicle 4 and the flight path F based on the information output from the information processing device 1.

The user terminal 3 displays on the map a port symbol P2 representing the alternative port 5a and a route R2 to the alternative port 5a in addition to the port symbol P1 of the “unavailable” port 5.

According to the aforementioned configuration, when the flight vehicle 4 requesting an emergency landing appears in the vicinity of the port 5 after a user's reservation to use the port 5, for example, the information processing device 1 can automatically switch over the availability of the port 5 according to a priority for each usage. In addition, the information processing device 1 is able to provide a user who may no longer use the port 5 irrespective of a reservation with a suggestion of the alternative port 5a, thus smoothly performing the navigation of the flight vehicle 4.

When the port 5 is used by the flight vehicle 4, the port 5 will transmit to the information processing device 1 the performance information including the airframe ID of the flight vehicle 4, a stay time which the flight vehicle 4 is staying at the port 5 or which the flight vehicle 4 has stayed at the port 5, and an amount of electricity consumed by the flight vehicle 4 that has stayed at the port 5. In the information processing device 1, the reception unit 121 receives the performance information from the port 5 to store the performance information in association with the port ID of the port 5 on the storage unit 11.

The stay time of the flight vehicle 4 staying at the port 5 exceeds the date and time to use the port 5 reserved by the user, the output unit 124 may notify the manager terminal 2 of the information representing an association between the user ID, the airframe ID, and the port ID. In addition, when another user makes a reservation to use the port 5 overrunning the date and time of use, the output unit 124 may output to another user's user terminal 3 the information about the alternative port 5a. Thus, it is possible to smoothly use the port 5 by preventing an unexpected event in which another flight vehicle 4 attempts a landing at the port 5 under the situation in which the flight vehicle 4 is staying at the port 5.

The port 5 may use a camera or a sensor to detect removal of the flight vehicle 4 from the port 5 due to an overrun of the date and time of use, thus transmitting to the information processing device 1 the information notifying the removal of the flight vehicle 4 from the port 5. In addition, a manager may use the management terminal 2 to transmit to the information processing device 1 the information notifying the removal of the flight vehicle 4 from the port 5. In the information processing device 1, when the reception unit 121 receives the information notifying the removal of the flight vehicle 4 from the port 5, the output unit 124 may transmit to the manager terminal 2 or the user terminal 3 the information notifying the removal of the flight vehicle 4 from the port 5. Accordingly, the information processing device 1 is able to rapidly resume the use of the port 5 overrunning the date and time of use.

The charging unit 125 is configured to determine an amount of payment claimed against the user based on the performance information stored on the storage unit 11.

For example, the charging unit 125 is configured to calculate an amount of payment based on at least one of a stay time of the flight vehicle 4 staying at the port 5 and an amount of electricity consumed by the flight vehicle 4 at the port 5. Alternatively, the charging unit 125 may change a manner of calculating an amount of payment based on the usage of the port 5 used by the flight vehicle 4.

The charging unit 125 is configured to generate the charging information including the determined amount of payment so as to store the charging information on the storage unit 11 in association with the user ID of the user who instructed the flight vehicle 4 to fly in the air. The charging unit 125 may generate and transmit the charging information to a charging server or the like configured to claim an amount of payment against the user. Accordingly, the information processing device 1 is able to charge against the user of the flight vehicle 4 an amount of payment according to the actual status of using the port 5 by the flight vehicle 4.

### [Sequence of Information Processing Method]

FIG. 7 is a sequence diagram of an information processing method to be executed by an information processing system, which includes a series of steps S 11 through S19. The manager terminal 2 accepts an input of the setting information including the use condition and the available duration on the setup screen (S11). In the information processing device 1, the reception unit 121 receives the setting information, i.e., the information input to the manager terminal 2. The setting unit 122 stores on the storage unit 11 the setting information representing an association between the use condition, the available duration, and port ID received by the reception unit 121.

The user terminal 3 accepts an input of the user information representing at least one of the user of the flight vehicle 4 and the flight vehicle 4, the date and time to use the port 5 by the flight vehicle 4, the usage of the port 5 used by the flight vehicle 4, and the airframe ID of the flight vehicle 4 to fly in the air (S12). In addition, the user terminal 3 may accept an input of the flight path or the flight area. In the information processing device 1, the reception unit 121 receives from the user terminal 3 the flight schedule information including the user ID of the user who used the user terminal 3 and the input information of the user terminal 3.

The determination unit 123 determines the user information and the date and time of use based on the flight schedule information received by the reception unit 121. The determination unit 123 determines the use condition and the available duration associated with the port ID with respect to a single port ID or each of multiple port IDs indicated by the setting information stored on the storage unit 11, wherein the determination unit 123 determines whether or not the port 5 corresponding to the port ID is available to the flight vehicle 4 based on a decision as to whether or not the user information satisfies the use condition and a decision as to whether or not the date and time of use are included in the available duration (S13).

The output unit 124 outputs to the user terminal 3 the information representing a single port 5 or multiple ports 5 which are determined to be available to the flight vehicle 4 by the determination unit 123 (S14). The user terminal 3 displays the output information of the information processing device 1 on a display screen thereof. The user terminal 3 may receive a user operation to reserve any one of available ports 5 (S15).

Due to a user operation to reserve any one port 5 on the user terminal 3, the reception unit 121 of the information processing device 1 receives from the user terminal 3 the reservation information including the port ID of the reserved port 5 and the date and time of use. The reception unit 121 stores on the storage unit 121 the reservation information received from the user terminal 3 in association with the user ID of the user who used the user terminal 3 and the airframe ID of the flight vehicle 4 (S16).

After the user makes a reservation to use the port 5 (e.g., during flight of the flight vehicle 4), the determination unit 123 determines the availability of the port 5 again (S17). According to the use condition in which a priority of usage of a first flight vehicle 4a is higher than a priority of usage of a second flight vehicle 4b, for example, the determination unit 123 determines that the port 5 is available to the first flight vehicle 4a but the port 5 is unavailable to the second flight vehicle 4b.

When the port 5 reserved by the user becomes unavailable to the flight vehicle 4, for example, the output unit 124 may extract from among a single port 5 or multiple ports 5, which are determined to be available to the flight vehicle 4 by the determination unit 123, the alternative port 5a which is different from the original port 5 reserved by the user and which is located in a predetermined range of area including the flight path (e.g., a range of one-kilometer (1 km) distance from the flight path), thus outputting the information about the alternative port 5a to the user terminal 3 (S18). The user terminal 3 displays the output information of the information processing device 1 on a display screen thereof.

When the port 5 is used by the flight vehicle 4, the port 5 transmits to the information processing device 1 the performance information including the airframe ID of the flight vehicle 4, the stay time of the flight vehicle 4 staying at the port 5, and an amount of electricity consumed by the flight vehicle 4 at the port 5. In the information processing device 1, the reception unit 121 receives the performance information from the port 5 so as to store the performance information on the storage unit 11 in association with the port ID of the port 5. The charging unit 125 determines an amount of payment claimed against the user based on the performance information stored on the storage unit 11. The charging unit 125 generates the charging information including the determined amount of payment so as to store the charging information on the storage unit 11 in association with the user ID of the user who instructed the flight vehicle 4 to fly in the air (S19).

### [Advantageous Effects of Exemplary Embodiment]

According to the exemplary embodiment, the information processing device 1 receives a manager's setting of the use condition and the available duration regarding the port 5 so as to determine whether or not the port 5 is available to the flight vehicle 4 based on a decision as to whether or not the date and time of use and the user information, which relate to the flight vehicle 4 attempting to use the port or the user of the flight vehicle 4, satisfy the available duration and the use condition respectively.

Accordingly, it is possible for the manager to switch over the availability of the port 5 for each time zone and for each flight vehicle 4 attempting to use the port 5 or for each user of the flight vehicle 4. Therefore, the information processing device 1 is able to make the port 5, at which the flight vehicle 4 will make a takeoff or landing, available to various users without being limited to specific users.

In this connection, it is possible to contribute to Sustainable Development Goals (SDGs) initiated by the United Nations (UN), i.e., Goal 9 “Industry, Innovation and Infrastructure”.

It is possible to conceive of various variations and modifications with respect to the information processing device 1 described below.

### [First Variation]

In contrast to the foregoing embodiment of the information processing device 1 configured to receive a reservation to use the port 5 before the flight vehicle 4 starts to fly in the air, it is possible to conceive of a first variation of the information processing device 1 configured to receive a reservation to use the port 5 after the flight vehicle 4 starts flying in the air. In the first variation, the reception unit 121 is configured to receive from the flight vehicle 4 the position information of the flight vehicle 4 during flight.

The determination unit 123 is configured to extract from among a single port ID or multiple port IDs indicated by the setting information stored on the storage unit 11 a port ID of a single port 5 or port IDs of multiple ports 5 located in a predetermined extraction range including the position of the flight vehicle 4. For example, the predetermined extraction range is defined as a circular area whose center point corresponds to the position of the flight vehicle 4 and whose radius corresponds to a continuously-flown distance of the flight vehicle 4. The continuously-flown distance can be determined and input by a user, or the continuously-flown distance may be determined based on the property of the flight vehicle 4 (e.g., flying speed and fuel efficiency) and the battery level of a battery installed in the flight vehicle 4. Using a single port ID or multiple port IDs extracted from the predetermined extraction range, the determination unit 123 may carry out the aforementioned determination similarly to the foregoing embodiment.

The output unit 124 is configured to output to the user terminal the information about a single port 5 or multiple ports 5 which are determined to be available to the flight vehicle 4 during flight by the determination unit 123 together with the information representing the flight path and the extraction range. The user terminal 3 is configured to display the output information of the information processing device 1 on the display screen thereof. Accordingly, the information processing device 1 is able to provide the user with the information representing the available port(s) 5, i.e., the reachable port(s) 5 which the flight vehicle 4 can reach from the current position.

FIG. 8 is a screenshot showing a flight status screen for the user terminal 3 to make a reservation of the port 5 during the flight of the flight vehicle 3, wherein symbols “Pt” means “port”. In FIG. 8, the user terminal 3 displays the flight path F and the current position of the flight vehicle 4 on the map based on the output information of the information processing device 1. In addition, the user terminal 3 displays on the map an extraction range A as a circular area about its center point corresponding to the current position of the flight vehicle 4 and a port symbol P3 representing the port 5 located inside the extraction range A. The user terminal 3 may solely display the available port 5, or the user terminal 3 may display an available port and an unavailable port in different manners.

When the user operates the user terminal 3 to make a reservation with respect to any one port 5 (e.g., when the user operates a reserve button), the reception unit 121 of the information processing device 1 receives from the user terminal 3 the reservation information including the port ID of the port 5 subjected to reservation and the date and time of use. Upon receiving the reservation information from the user terminal 3, the reception unit 121 stores on the storage unit 11 the reservation information in association with the user ID of the user who operated the user terminal 3 and the airframe ID of the flight vehicle 4. Accordingly, the information processing device 1 is able to receive a reservation to use the port 5 during the flight of the flight vehicle 4.

Upon receiving the battery level of a battery installed in the flight vehicle 4 during flight, the output unit 124 may output to the user terminal 3 the information about a single port 5 or multiple ports 5 which are determined to be available to the flight vehicle 4 by the determination unit 123 on the condition that the battery level becomes equal to or below a predetermined threshold value. Accordingly, the information processing device 1 is able to provide the user with a suggestion to charge the battery of the flight vehicle 4 at the port 5.

### [Second Variation]

The second variation is designed such that the determination unit 123 is configured to determine whether or not the port 5 having the port ID is available to the flight vehicle 4 based on external information other than the user information in addition to a determination as to whether or not the user information satisfies the use condition.

As the external information, the determination unit 123 may use the information representative of a vacancy status as to the vacancy of a shed (or a warehouse) for keeping products (or goods) to be transported by the flight vehicle 4. In this case, the manager may set the vacancy of a shed for keeping products as the use condition. The reception unit 121 receives from a predetermined server the vacancy information representing a vacancy status of a shed for keeping products to be transported by the flight vehicle 4. When the vacancy of a shed for keeping products has been set to the use condition, the determination unit 123 determines that the port 5 is available to the flight vehicle 4 on the condition that the vacancy status of a shed indicates the vacancy of a shed.

As the external information, the determination unit 123 may use the regional information corresponding to the use condition for each region. For example, the use information for each region may incapacitate the flight vehicle 4 from flying over a specific region such as a residential area, incapacitate the flight vehicle 4 from flying in a specific time zone such as midnight and the morning, or incapacitate the flight vehicle 4 having an airframe size above a predetermined reference value from flying over the designated region. In this case, upon acquiring the use condition of the region locating the port 5, the determination unit 123 determines that the port 5 is available to the flight vehicle 4 on the condition that the regional information corresponding to the use condition of the region (e.g., the time zone or the airframe size to incapacitate the flight vehicle 4 from flying in the region) satisfies the use condition of the region.

In addition, the determination unit 123 may determines that the flight vehicle 4 is not permitted to use the port 5, irrespective of a decision as to whether or not the user information satisfies the use condition, according to the external information such as the weather information about typhoons and restriction orders issued by a public authority such as a local municipality. For example, restriction orders indicate a limitation for the flight vehicle 4 to make a flight or a takeoff/landing in a specific region. For example, the weather information indicates unfavorable weather such as gales and typhoons in a specific region or any other weathers incapacitating the flight vehicle 4 from making a flight or a takeoff/landing. The reception unit 121 is configured to receive the weather information or restriction orders from a predetermined server.

The determination unit 123 determines that the port is unavailable to the flight vehicle 4 when the weather information or restriction orders received by the reception unit 121 indicate an event incapacitating the flight vehicle 4 from making a flight or a takeoff/landing in the region locating the port 5. In this case, the output unit 124 outputs to the user terminal 3 operated by the user who made a reservation to use the port 5 the unavailable information indicating that the port 5 is unavailable to the flight vehicle 4, thus nullifying the reservation information representing a reservation to use the port 5 on the storage unit 11. In addition, the output unit 124 may output to the flight management system for controlling the flight of the flight vehicle 4 the unavailable information indicating that the port 5 is unavailable to the flight vehicle 4.

According to the second variation, the information processing device 1 may determine whether or not the port 5 is available to the flight vehicle 4 based on various types of external information in addition to the user information relating to the flight vehicle 4 or the user of the flight vehicle 4.

Heretofore, the present invention has been described by way of the foregoing embodiments (e.g., the exemplary embodiment and its variations), wherein the technical scope of the invention is not necessarily limited to the foregoing embodiments; hence, it is possible to create and introduce any other variations and modifications within the subject matter of the invention. For example, it is possible to physically or functionally disperse or integrate part or the entirety of the foregoing devices in arbitrary units of components. In addition, the present invention may embrace any new examples produced by arbitrarily combining the foregoing embodiments. It can be said that new examples produced by combinations of the foregoing embodiments will offer the same advantageous effects as the exemplary embodiment.

Each of processors realizing the functions of the information processing device 1, the manager terminal 2, and the user terminal 3 may serve as a subject to execute steps (or processes) included in the flight management method shown in FIG. 7. That is, processors of the information processing device 1, the manager terminal 2, and the user terminal 3 may read from memory programs implementing the information processing method of FIG. 7 so as to execute programs to execute the information processing method of FIG. 7. In this connection, it is possible to partially omit the foregoing steps included in the information processing method of FIG. 7, to change the order of the foregoing steps, or to carry out the foregoing steps in parallel.

While the exemplary embodiment and variations of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

1. An information processing device comprising:
a reception unit configured to receive from a user terminal operated by a user to control a flight vehicle to make a takeoff or landing at a port, user information relating to at least one of the flight vehicle and the user as well as a date and time of use scheduled for the flight vehicle to use the port and configured to receive from a manager terminal operated by a manager to manage the port, port identification information to identify the port, an available duration to use the port, and a use condition to use the port which is set for each available duration;
a setting unit configured to store on a storage unit, setting information representing an association between the port identification information, the available duration, and the use condition set for each available duration which are received by the reception unit;
a determination unit configured to determine whether or not the port identified by the port identification information is available to the flight vehicle based on a decision as to whether or not the user information satisfies the use condition set for each available duration and a decision as to whether or not the date and time of use are included in the available duration; and
an output unit configured to output to the user terminal information about the port which the determination unit determines to be available to the flight vehicle.

2. The information processing device according to claim 1, wherein the output unit is configured to output to the user terminal a route from a position of the flight vehicle to a position of the port which the determination unit determines to be available to the flight vehicle.

3. The information processing device according to claim 1, wherein the output unit is configured to output to the user terminal the information about the port which the determination unit determines to be available to the flight vehicle and which belongs to a predetermined range of area including a flight path along which the flight vehicle is scheduled to fly.

4. The information processing device according to claim 1, wherein the storage unit is configured to store the use condition representing a plurality of usages of the port, and wherein the determination unit is configured to determine that the port is available to the flight vehicle when a usage of the flight vehicle is included in the plurality of usages indicated by the use condition.

5. The information processing device according to claim 4, wherein the storage unit is configured to store the use condition representing a priority of each usage among the plurality of usages, and wherein when the flight vehicle competes with a secondary flight vehicle for use of the port, the determination unit is configured to determine that the port is available to the flight vehicle while the port is unavailable to the secondary flight vehicle when the flight vehicle has a higher priority of usage than the secondary flight vehicle.

6. The information processing device according to claim 1, wherein the storage unit is configured to store the use condition representing user attributes applicable to the port, and wherein the determination unit is configured to determine that the port is available to the flight vehicle when a user attribute of the user who attempts to control the flight vehicle is included in the user attributes indicated by the use condition.

7. The information processing device according to claim 1, wherein the storage unit is configured to store the use condition representing airframe properties applicable to the port, and wherein the determination unit is configured to determine that the port is available to the flight vehicle when an airframe property of the flight vehicle is included in the airframe properties indicated by the use condition.

8. The information processing device according to claim 1, comprising: a charging unit configured to determine an amount of payment claimed against the user based on at least one of a stay time of the flight vehicle staying at the port and an amount of electricity consumed by the flight vehicle at the port, thus generating charging information including the amount of payment.

9. An information processing method comprising:
receiving from a user terminal operated by a user to control a flight vehicle to make a takeoff or landing at a port, user information relating to at least one of the flight vehicle and the user as well as a date and time of use scheduled for the flight vehicle to use the port;
receiving from a manager terminal operated by a manager to manage the port, port identification information to identify the port, an available duration to use the port, and a use condition to use the port which is set for each available duration;
storing on a storage unit, setting information representing an association between the port identification information, the available duration, and the use condition set for each available duration which are received;
determining whether or not the port identified by the port identification information is available to the flight vehicle based on a decision as to whether or not the user information satisfies the use condition set for each available duration and a decision as to whether or not the date and time of use are included in the available duration; and
outputting to the user terminal information about the port which the determination unit determines to be available to the flight vehicle.
